(19) United States
(12) Patent Application Publication
(10) Pub. No.: US 2023/0025874 A1
(43) Pub. Date: Jan. 26, 2023

(54) MODULAR PLANT GROWTH SYSTEM

(71) Applicant: 2327100 ALBERTA INC., Wetaskiwin (CA)

(72) Inventor: Emmanuel L'ECUYER, Edmonton (CA)

(21) Appl. No.: 17/786,021

(22) PCT Filed: Dec. 17, 2020
(86) PCT No.: PCT/CA2020/051740

§ 371 Date: Jun. 16, 2022

Related U.S. Application Data
(60) Provisional application No. 62/950,996, filed on Dec. 20, 2019.
(60) Provisional application No. 63/055,393, filed on Jul. 23, 2020.

(51) Int. Cl. A01G 9/14; E04B 1/348; E04H 5/08

(52) U.S. Cl. CPC A01G 9/1423; E04B 1/34869; E04H 5/08

(57) ABSTRACT

A modular plant growth system comprising a plurality of modules having two lateral walls transversally spaced apart and opposite to one another, defining a walkway there between, and a upper member connecting a upper portion of the lateral walls to each other, wherein at least one of the lateral walls is configured to receive a growth box and the modules are configured to be superposed, the upper member of a lower module being a flooring for the walkway of a superposed module. The growth box comprising a generally rectangular shell, a panel defined within a front face leading to a cavity within the shell and at least one support structure extending vertically defining a groove within, wherein the cavity is configured to receive planting growth material and the groove is configured to receive a support member.

### BACKGROUND

Some growth techniques, such as aeroponics for instance, can involve growing plants in a controlled gaseous environment, and can involve exposing the plants to water in the form of air borne humidity, rather than in the form of soil humidity.

While growth techniques were satisfactory to a certain extent, there always remains room for improvement, such as in the ease of fabrication and assembly of plant growing facilities, for instance.

### SUMMARY

In accordance with one aspect, there is provided a modular plant growth system wherein boxes configured to contain portions of plants, such as roots for instance, can be stacked on top of one another, potentially for two or more stories high (e.g. to 5 stories high). A wall of the boxes can be provided with doors or other panels, which can be used to hold the plants. In one embodiment, the panels have apertures configured to receive fitting supporting the plants. A walkway structure can be provided, which can include a plurality of stories of elongated walkways, and the boxes can be stacked on both sides of the walkways.

In accordance with another aspect, there is provided a modular plant growth system comprising a plurality of modules having two lateral walls transversally spaced apart and opposite to one another, defining a walkway there between, and a upper member connecting a upper portion of the lateral walls to each other, wherein at least one of the lateral walls is configured to receive a growth box and the modules are configured to be superposed, the upper member of a lower module being a flooring for the walkway of a superposed module.

In accordance with another aspect, there is provided a box for a modular plant growth system.

In accordance with yet another aspect, there is provided a growth box comprising a generally rectangular shell having a back face, a front face, a top face and a base, a panel defined within the front face leading to a cavity within the shell and at least one support structure extending vertically along the front face, from the base to the top face, defining a groove within, wherein the cavity is configured to receive planting growth material and the groove is configured to receive a support member.

Many further features and combinations thereof concerning the present improvements will appear to those skilled in the art following a reading of the instant disclosure.

### DESCRIPTION OF THE FIGURES

In the figures,

FIG. 1 is an oblique schematic view of the three story growth facility with a modular plant growth system;

FIG. 2A is an oblique view of a single module of a modular plant growth system on a growth facility flooring configured to receive a modular plant growth system;

FIG. 2B is the portion 2B-2B of FIG. 2A, shown enlarged;

FIG. 3A-3D are views of an example growth box for a modular plant growth system;

FIG. 4A is an oblique view of eight (8) modules of a modular plant growth system placed in a row on a growth facility flooring configured to receive a modular plant growth system;

FIG. 4B is the portion 4B-4B of FIG. 4A, shown enlarged;

FIG. 5 is a side schematic view of another embodiment of a modular plant growth system, wherein rows of modules are stacked above one another;

FIG. 6A is an oblique view of 80 modules of a modular plant growth system placed on a growth facility flooring, with various rows placed side by side and stacked over one another so as to define a plurality of walkways; and

FIG. 6B is the portion 6B-6B of FIG. 6A, shown enlarged.

### DETAILED DESCRIPTION

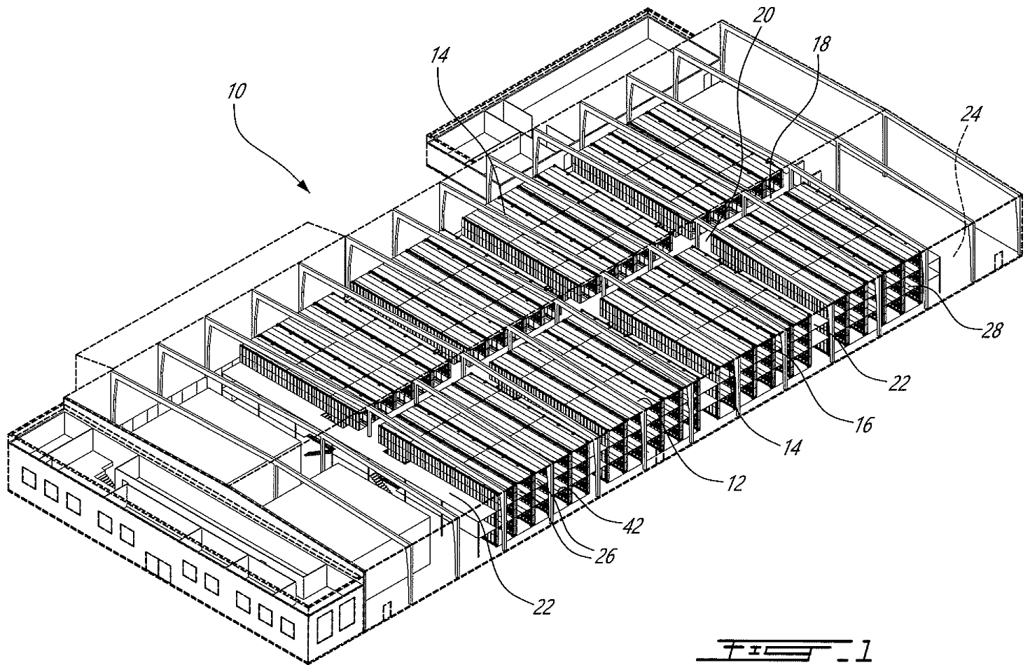

FIG. 1 shows an oblique schematic view of a growth facility 10 configured to receive a modular plant growth system 12. In this example, the growth facility 10 contains a number of modular plant growth systems 12, comprising various modules 14 connected to one another. Each module 14 contains growth boxes 16, in which at least a portion of a plant (e.g. roots, foliage, or the entire plant) is contained and in which the environment is controlled. As will be further discussed below, such enclosed growth boxes 16 are arrayed in an effort to optimize space usage.

In this embodiment, the growth facility 10 can have plurality stories, three for instance, and pathways 18 on each one its stories. In this example, the pathways 18 includes a central path 20 extending longitudinally along the growth facility 10 and connected to a number of branching paths 22 extending towards the facility's exterior walls 24. A spacing is present between the different branching paths 22 and is configured to receive a modular plant growth system 12 of corresponding stories, extending longitudinally in the same directions as the branching paths 22. As will be further discussed below, the modular plant growth system 12 can contain various rows 26 of modules 14, holding the growth boxes 16 vertically and defining a plurality of walkways 28 therein.

The growth facility 10 can be designed to achieve a relatively high amount of production per square foot, and can do so by providing a significant amount of growing space vertically. The use of independent growth boxes 16 allows to form a plurality of independent micro-environments where the air can be cleaned, the temperature controlled, and the humidity/nutrients can be controlled. If any one of the independent growth boxes 16 becomes contaminated with mould spores or any other pathogen, for instance, the fact that its space is enclosed can protect the contamination from spreading to other ones of the micro-environments (in other growth boxes 16, for instance).

It will be understood that the growth facility 10 described above can be altered without departing from the present disclosure. In alternate embodiments, the growth facility 10 can have more or less floors than described above, be of varying dimensions and/or have divisions for different controlled environments. In yet another embodiment, the growth facility 10 can be oriented in a different direction to the pathways, such as extending perpendicularly to the length of the branching paths.

The modular plant growth system 12 and its components will now be discussed below.

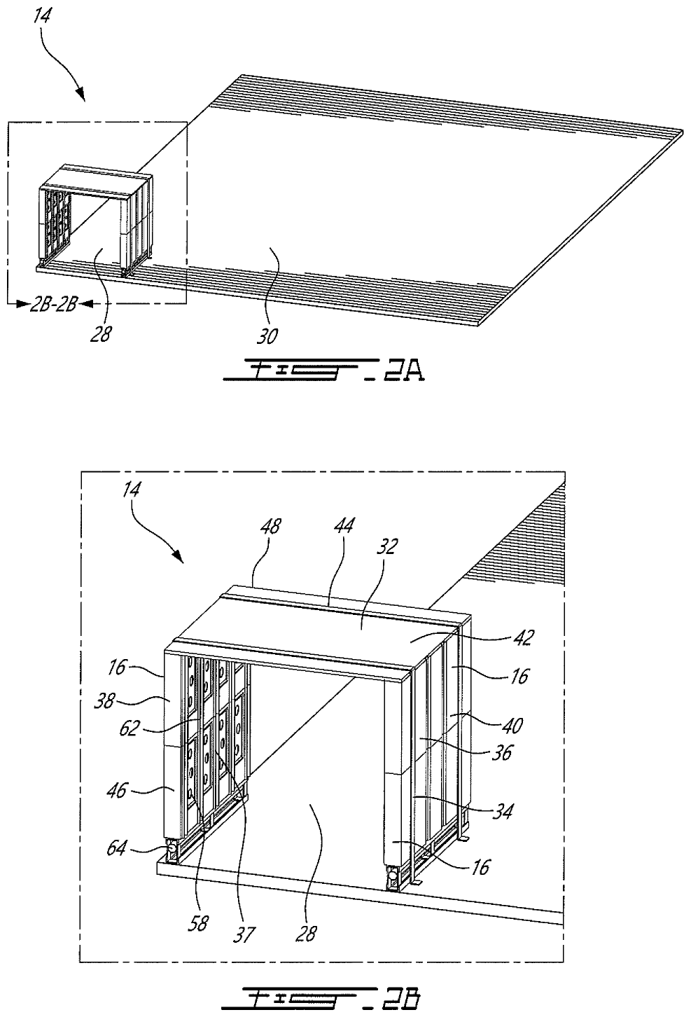

Attention is brought to FIG. 2A showing a growth facility 10 flooring 30 configured to receive a modular plant growth system 12. In this figure, an embodiment of a module 14 of the modular plant growth system 12 is shown. As perhaps best seen in FIG. 2B, showing section 2B-2B of FIG. 2A enlarged, the module 14 includes an upper horizontal member 32 and vertical beams 34 placed on the outer side 36 of stacked growth boxes 16. The growth boxes are found on a first 38 and second lateral wall 40 of the module 14. In this embodiment, the first 38 and second lateral walls 40 are transversally spaced apart and define a walkway 28 there between.

In this example, the upper horizontal member 32 is a floor grating 42, defining a surface on which one may walk when additional module(s) 14 are stacked above one another. The floor grating 42 is held in place by grating beams 44, connected to corresponding vertical beams 34 of the lateral walls 38, 40 of the module 14. The module 14 is anchored to the flooring 30 by fastening the vertical beams 34 to the flooring 30 of the growth facility 10, this can be done by bolting, welding or any other suitable method, including fastening the vertical beams 34 to an intermediate flooring mount, for instance. In an alternate embodiment, the mounting method is omitted altogether.

Still referring to FIG. 2B, the two vertical beams 34 and the grating beam are connected to one another are placed equidistantly from the front end 46 and back end 48 of the module 14. It is understood that the vertical beams' 34 and/or grating beams' 44 position and quantity can be altered without departing from the present disclosure. For instance, in an alternate embodiment, the grating beams are omitted. In yet another embodiment, the vertical beams and grating beams are placed at the front end 46 and back end 48 of the module 14, for instance.

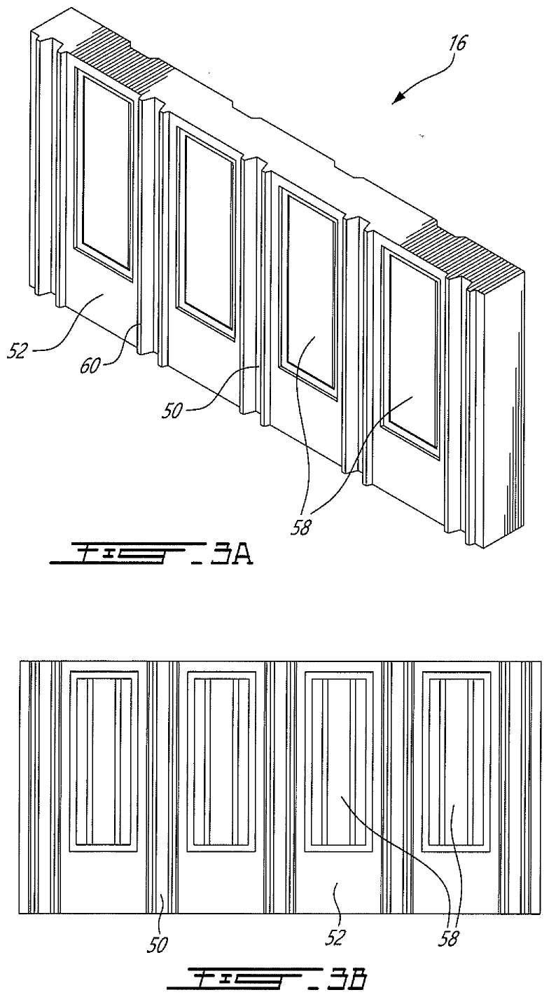

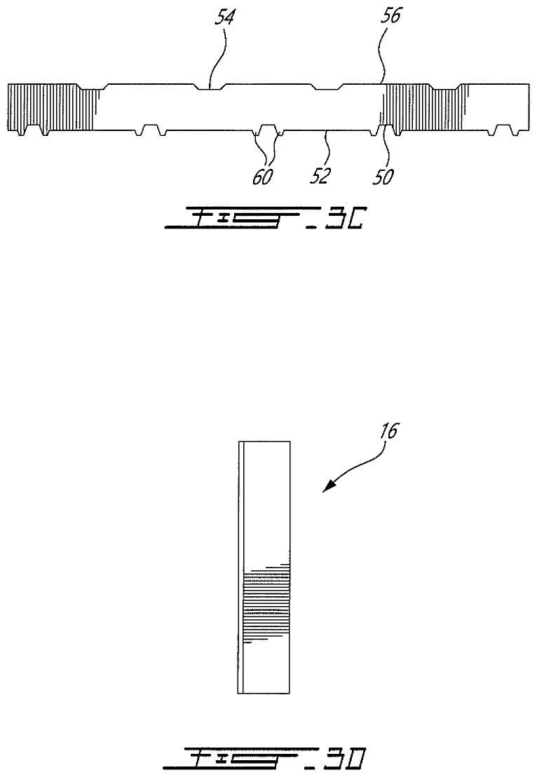

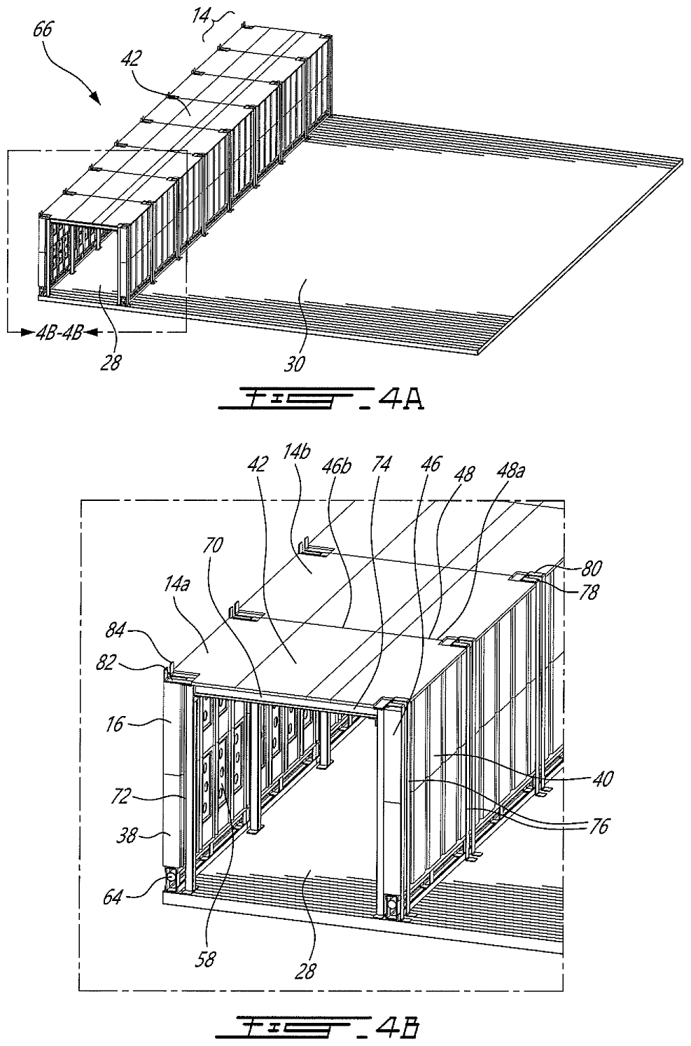

The exemplary module of FIG. 2B can include various growth boxes 16 stacked on either one or both of the lateral walls 38, 40. The module 14 shown in FIG. 2B contains two (2) growth boxes 16 on each one of its lateral walls 38, 40. Attention is now brought to FIG. 3A-3D, showing various views of an exemplary growth box 16 for a modular plant growth system 12. The growth box 16 has a number of vertically oriented grooves 50, 54 configured to snugly receive straps, beams or any adequate support member used to hold the stacked growth boxes 16 to one another and against the structure of a modular plant growth system 12, for instance. The front grooves 50, on a front face 52 of the growth box 16, and the back grooves 54, on the back face 56 of the growth box 16, are staggered longitudinally from one another. In this example embodiment, the grooves 50, 54 are vertically oriented. The growth box 16 is made of plastic and is hollow, defining a cavity within configured to receive planting growth material. It is however understood that alternate materials can be used without departing from the present disclosure.

In this embodiment, the growth box 16 includes four adjacent panels 58 into which one or more plants can be fixed. It can however be understood that the panels 58 can be altered without departing from the present disclosure. For instance, in alternate embodiments, each panel may contain a plurality of apertures, where each aperture can receive a fitting supporting a plant. In another embodiment, the panel can be a mesh permitting plant growth throughout, for instance.

Still referring to FIGS. 3A-3D, the front groove 50 is placed between adjacent panels 58 and at the extremities of the growth box's 16 length, while the back grooves 54 are longitudinally aligned with the panels 58 found on the front face 52. The front grooves 50, which are configured to receive straps for instance, are defined within respective support structures 60 being thicker than the shell of the growth box 16 and act as posts or columns to support the weight of additional growth boxes 16 stacked above the one shown. The growth boxes 16 can have dimensions of approximately 4 feet by 8 feet, for instance, and be 20 inches deep, can be designed to allow stacking up to 5 stories high, such as 40 feet high or 10 units high, for instance. In certain embodiments, it can be preferred to paint the growth boxes in black to protect the roots of the plants therein from light.

It is often desired to maintain the humidity level in the growth boxes 16 to a target value, within certain tolerances. Looking at one growth box 16, such as shown in FIG. 3A for instance, the humidity level can be monitored with one or more humidity sensors (not shown), and the humidity level can be raised, as water is absorbed by the plants, by providing jets of humid air via diffusers having a nozzle penetrating into the growth boxes (not shown). Nutrients can be mixed into the water to favour efficient plant growth.

It may be understood that the growth box's 16 dimensions, shape, grooves 50, 54 and/or panel(s) 58 may be altered without departing from the present disclosure. For instance, in an alternate embodiment, the growth box is shorter in length and only includes two panels. In yet another embodiment, the growth box's length is such that only one panel is present in each growth box and various growth boxes can be placed side by side in the same module lateral wall, for instance.

Returning to FIG. 2B, in this exemplary module 14, two growth boxes 16 are stacked above one another on each lateral wall 38, 40 of the module 14, where the outer side 36 of the growth box 16, facing away from the walkway 28 and corresponding to the back face 56 identified above, may be held in place by the vertical beams 34. The inner side 37 of the growth box 16, facing the walkway 28 and corresponding to the front face 52 identified above, is held by straps 62 in this embodiment. The inner side 37 of the growth boxes 16, facing the walkway 28, contain the panels 58 such that the foliage of the plants is exposed to the walkway 28 while the roots of the plants are enclosed in the growth boxes 16.

In this exemplary embodiment, piping 64 is passed through a passage under the growth boxes 16, extending the length of the walkway 28. The piping 64 is used to transport water, nutrients and/or other products along the modules 14 in the module plant growth system 12. It is understood that the piping 64 can be modified, such as by passing it between the stacked growth boxes 16 for instance, or omitted altogether without departing from the present disclosure.

As will be further exemplified below, the module 14 can be configured to receive a plurality of additional modules 14 one behind the other, in line, defining a module row 66, such that a longitudinal walkway 28 is defined therein. The length of the module row 66 is modulable by increasing or decreasing the number of modules 14 placed in line. Each module row 66 can be further configured to receive additional module row(s) 66 on its lateral sides, such that a first lateral wall 38 of a first module is in abutment with a second lateral wall 40 of a second module and that two growth boxes 16 placed alongside each other in their respective modules 14 would be back-to-back (having the back face 56 of each growth box 16 face the other), such that their foliage (and respective front face 52) is exposed in their respective walkways 28. The module rows 66 can further be configured to receive additional module rows 66 superposed on the floor grating 42 of the underlying modules 14. Each additionally row of modules 66 creating an additional walkway 28, where the series of floor gratings 42 from the underlying row of modules 66 creates a walkway flooring 68 for the walkway 28 of the above row of modules 66.

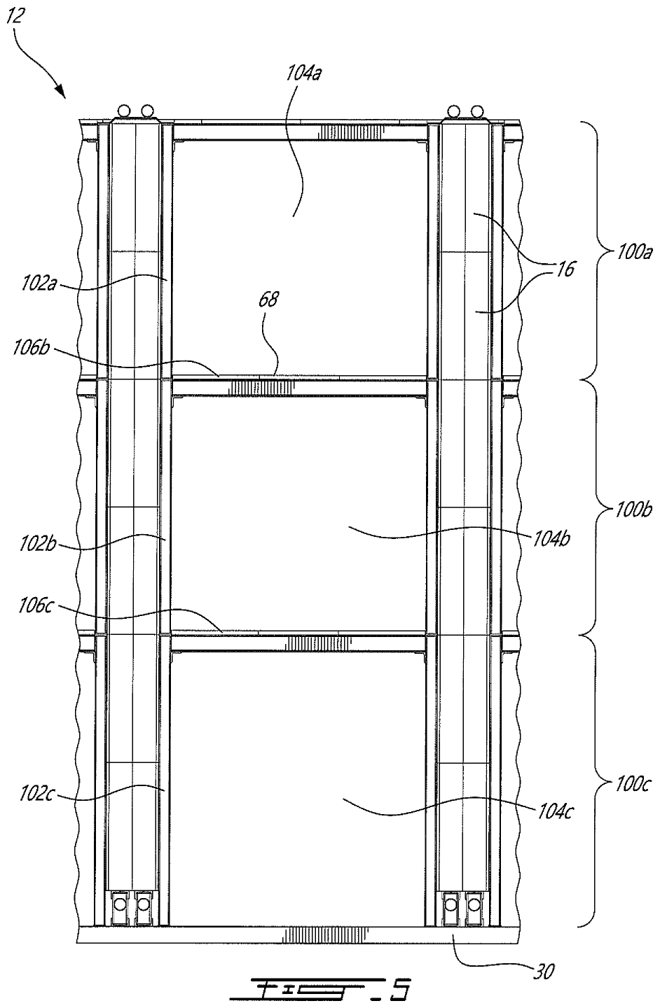

Attention is brought to FIG. 4A, showing a module row 66 of yet another embodiment of the modular plant growth system 12. In this figure, one can see eight (8) modules 14 in line, defining a module row 66. As perhaps best seen in FIG. 4B, showing section 4B-4B of FIG. 4A, the module 14 in this embodiment includes an internal structure 70 along the front end 46 and back end 48 of the individual modules 14. The front end 46 and back end 48 corresponding to the extremities of the length of the individual growth boxes 16. The internal structure 70 includes internal vertical beams 72 on each of the lateral wall 38, 40 and a grating beam 74. The grating beam 74 extending generally horizontally between the two opposite side vertical beams 72 (one on each lateral wall 38, 40) of the module 14, on the underside of the floor grating 42, where the walkway 28 is defined.

The end of a first module 14a that interfaces with a second, adjacent, module 14b, can only use one internal vertical member per lateral wall and one internal grating beam at the interface. For instance, in this example, the back end 48a of the first module 14a interfaces with the front end 46a of the second module 14b and only uses one internal grating beam 74, one vertical beam 72 at the first lateral wall 38 and one vertical beam 72 at the second lateral wall 40 at the interface of these two modules 14a, 14b. It is understood that, in alternate embodiments, the corresponding structural members (whether it be the internal structure 70 or other structural members) of each adjacent module 14 can be fastened together, for instance. In yet another alternate embodiment, the fastening means between corresponding structural members of each adjacent module 14 can be omitted, such as by placing the modules in abutment with one another, without departing from the present disclosure.

As per the previous embodiment, disclosed above, the module row 66 can define a walkway 28, wherein growth boxes 16 are stacked on both lateral walls 38, 40 of the modules 14. In this example, the growth boxes 16 are placed on the outer side of the internal vertical beams 72. The side of the growth boxes 16 facing the walkway 28 (front face 52 of the growth boxes 16) contain the panels 58, so that foliage of the plants is exposed to the walkway 28, while the roots of the plants are enclosed in the growth boxes 16. Piping 64 is passed through a passage under the growth boxes 16, extending the length of the walkway 28 and is used to transport water, nutrients and/or other products along the module 14 and/or module row 66. The module row 66 is anchored to the flooring 30 by fastening the internal vertical beams 72 to the flooring 30 of the growth facility 10. This can be done by bolting, welding or any other suitable means. It is understood that the vertical beams 72 can, in alternate embodiments, be fastened to an intermediate flooring mount, for instance.

Still referring to FIG. 4B, the modules 14 further include external vertical beams 76, parallel and aligned with the internal vertical beams 72 of the internal structure 70, offset from the internal structure's 70 vertical beam 72 on the corresponding lateral wall 38, 40 so as to receive a growth box 16 in between the internal vertical beam 72 and the external vertical beam 76. The external vertical beams 76 extending vertically from the flooring 30 towards the floor grating 42 and having its top extremity 78 bent such as to extend generally horizontally over the top of the growth box 16, towards the internal structure 70. In this example, the top extremity 78 of the external vertical beam 76 is in contact and fastened to the internal structure 70, via a grating fastener 80. The external vertical beams 76 can play a structural role for the module 14, while further supplying a supporting role for the superposed growth boxes 16. It is understood that in alternate embodiments, the external vertical beams 76 can be replaced by any other suitable means or omitted without departing from the present disclosure.

As is shown on the left-hand side of FIG. 4B, a clip 82 can be connected to the internal structure 70 and extend towards the side of the growth box 16 facing away from the walkway 28 (back face 56 of the growth boxes 16). The clip 82 contains protrusions 84 extending generally vertically from its end and used to support and hold the growth boxes 16 in place, effectively inhibiting the growth box 16 from pivoting outwardly from the module 14 lateral wall 38, 40. In this embodiment, both a clip 82 and an external vertical beam 76 are used in their corresponding lateral wall 38, 40 of the module row 66. It will be understood that in alternate embodiments, only the clip 82, only the external vertical beam 72 and/or a combination of the two can be used without departing from the present disclosure.

It is understood that the module row 66 length can be adjusted by adding or removing modules 14 in line and may be further configured to receive additional module rows 66 on either lateral side, where the first 38 and second 40 lateral walls are defined, as well as superpose additional module rows 66 above one another.

Attention is now brought to FIG. 5, showing a schematic side view of another embodiment of a modular plant growth system 12. Module rows 100a, 100b, 100c are shown superposed above one another, making a three (3) story modular plant growth system 12. In this embodiment, a lower portion of the internal structure 102b of the modules 14 in the middle module row 100b is aligned and superposed on the upper portion of the modules 14 in the lower module row 100c and fastened in place by any suitable means, such as bolting or welding for instance. Similarly, a lower portion of the internal structure 102a of the modules 14 in a top module row 100a is aligned and superposed on the modules 14 in the middle module row 100b and fastened in place. Each module 14 contains growth boxes 16 in each of the lateral walls 38, 40.

In an alternate embodiment, the internal structure plays no supporting role with regards to the growth boxes 16. Alternatively, the stacked growth boxes 16 can be strapped in a manner for a strap to entirely loop around the stacked growth boxes 16 vertically, and to regularly be secured to the module's 14 structure, for instance.

The superposed module rows 100a, 100b, 100c define walkways 104a, 104b, 104c, which are aligned and correspond with the pathways 18 of the floors in the growth facility 10 in which it is placed, such as those seen in FIG. 1. Each superposed row of modules 100a, 100b creates an additional walkway, where the floor gratings 106b, 106c from the underlying row of modules 100b, 100c define a walkway flooring for the walkways 104a, 104b of the above row of modules 100a, 100b. In the embodiment shown in FIG. 5, a person walking through the walkway of the middle module row 100b is standing on the floor grating 106c corresponding to the lower module row 100c.

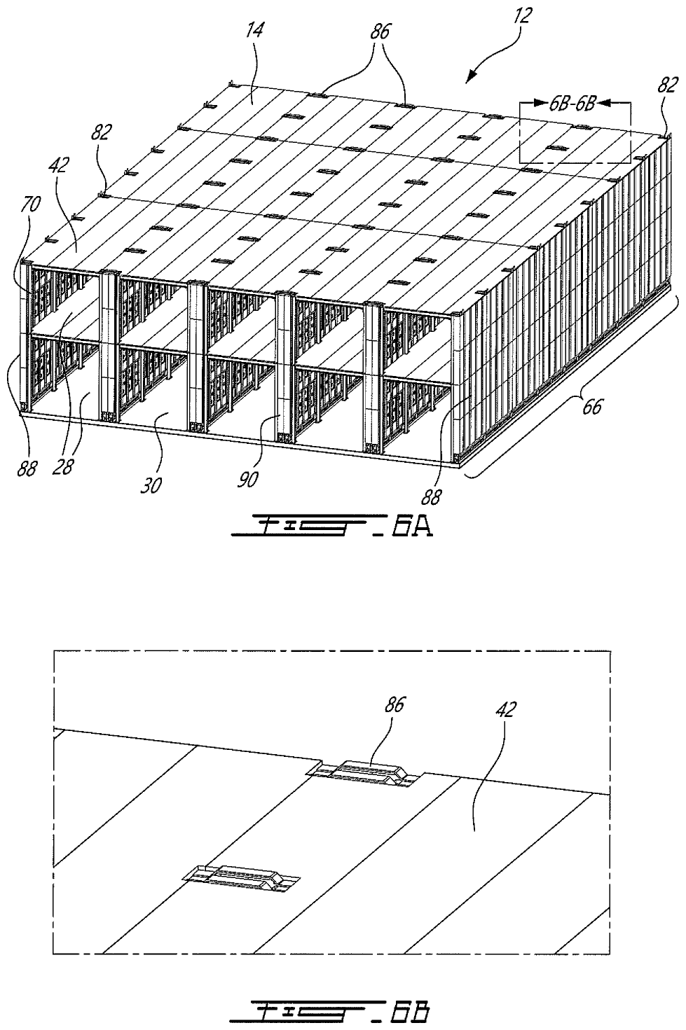

Attention is now brought to FIG. 6A, showing an oblique view of eighty (80) modules 14 of a modular plant growth system 12 covering a growth facility flooring 30, forming ten (10) eight (8) module rows 66 placed side by side and superposed so as to define multiple walkways 28. Each walkway 28 has growth boxes 16 on both of the lateral walls 38, 40 of each module 14, where, in adjacent module rows 66, the growth boxes 14 are placed back to back and the panels 58 of each growth box 16 face their respective walkway 28. As previously disclosed, the module rows 66 constructed over an underlying module row 66 uses the floor grating 42 of the underlying module row 66 as a walking surface for the walkway 28 of the above module row 66. In this example, the modules 14 contain internal structures 70, such as seen in FIGS. 4A and 4B. For the sake of conciseness, only the differences from the previously disclosed embodiments will be discussed below.

In this example and as perhaps best seen in FIG. 6B, the module rows 66 placed side by side are held together by links 86. The links 86 connect the internal structures 70 of adjacent modules 14 together and are shaped so as to define a space capable of receiving part of the body of the growth boxes 16 between the internal structures 70 of the corresponding adjacent modules 14. It is understood that the link 86 can be altered or omitted without departing from the present disclosure. Returning to FIG. 6A, the modular plant growth system 12 in this particular embodiment does not have external vertical beams (shown as 76 in FIG. 4B), but has the previously disclosed clips 82 on both terminal walls 88 of the modular plant growth system 12. It is understood that the clips 82 can be altered or omitted without departing from the present disclose. The modules 14 placed side-by-side share a common wall 90, where the back face 56 of the growth boxes 16 are placed back-to-back, in abutment with each other between the internal structure 70 of the adjacent modules 14, such that the front face 52 of the growth boxes 16 (containing the panel 58) is accessible from their respective walkways 28.

As can be understood, the examples described above and illustrated are intended to be exemplary only. For instance, the floor gratings of the modular plant growth system can be replaced by any suitable alternative, such as glass for instance, without departing from the present disclosure. In another embodiment, the growth boxes are only placed on one of the lateral walls of the modules, for instance. The scope is indicated by the appended claims.

1. A modular plant growth system comprising:
a plurality of modules having two lateral walls transversally spaced apart and opposite to one another, defining a walkway there between, and a upper member connecting a upper portion of the lateral walls to each other;
wherein at least one of the lateral walls is configured to receive a growth box and the modules are configured to be superposed, the upper member of a lower module being a flooring for the walkway of a superposed module.

2. The modular plant growth system of claim 1, wherein the modules are further configured be placed in succession, such that a front end of a first module is placed in abutment with a back end of a second module.

3. The modular plant growth system of claim 2, wherein the first module and the second module share an internal structure at the abutment.

4. The modular plant growth system of claim 3, wherein the internal structure is configured to fasten the front end of the first module to the back end of the second module.

5. The modular plant growth system of claim 1, wherein the modules are further configured to be placed side-by-side, such that a first lateral wall of a first module is placed in abutment with a second lateral wall of a second module.

6. The modular plant growth system of claim 5, further comprising a link configured to fasten the first lateral wall of the first module to the second lateral wall of the second module.

7. The modular plant growth system of claim 5, wherein the first lateral wall and second lateral wall placed in abutment define a common wall.

8. The modular plant growth system of claim 7, wherein a first and second growth box are configured to be received in abutment with each other within the common wall.

9. The modular plant growth system of claim 1, wherein the upper member is a floor grating.

10. The modular plant growth system of claim 1, wherein the modules are configured to receive a growth box on both lateral walls.

11. The modular plant growth system of claim 1, wherein the lateral walls are configured to receive a plurality of growth boxes.

12. The modular plant growth system of claim 11, wherein the plurality of growth boxes are superposed one above the other.

13. The modular plant growth system of claim 1, wherein the growth box is hollow, comprises at least one panel and is configured to receive plants therein.

14. The modular plant growth system of claim 13, wherein the growth box comprises a plurality of panels and a groove between the panels.

15. The modular plant growth system of claim 1, wherein a height of the modules correspond to the height of a floor in a growth facility, the walkway of each of the modules configured to be accessible from a corresponding floor of the growth facility.

16. The modular plant growth system of claim 1, wherein the modules further have an external vertical beam on each lateral wall.

17. The modular plant growth system of claim 1, wherein the modules further have at least one internal structure, the internal structure comprising a first internal vertical beam on the first lateral wall, a second internal vertical beam on the second lateral wall and a grating beam connecting the first internal vertical beam to the second internal vertical beam.

18. The modular plant growth system of claim 17, wherein the modules have at least two internal structures, a first internal structure at a front end of the module and a second internal structure at a second end of the module.

19. The modular plant growth system of claim 18, wherein the modules further comprise an external vertical beam parallel to an internal vertical beam of the internal structure and outwardly spaced apart from the internal vertical beam.

20. The modular plant growth system of claim 19, wherein an extremity of the external vertical beam is secured to the internal structure.

21.-41. (canceled)
